(19) United States
(12) Patent Application Publication
(10) Pub. No.: US 2009/0100701 A1
(43) Pub. Date: Apr. 23, 2009

(54) System for sealing an apparatus

(75) Inventor: James W. Ulrich, Fort Lee, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Wyssmont Co. Inc., Fort Lee, NJ (US)

(21) Appl. No.: 11/975,144

(22) Filed: Oct. 17, 2007

(51) Int. Cl. F26B 25/08; F16J 15/16; F16C 33/72

(52) U.S. Cl. 34/242; 277/387; 384/94

(57) ABSTRACT

An apparatus for processing materials provides a material processing chamber, formed from an enclosure having a top and a bottom. The bottom has an opening therein, and a shaft extends through the opening and into the chamber. A bearing assembly may be arranged about a lower portion of the shaft, the bearing assembly including a bearing extension arranged about a portion of the shaft. The bearing extension has a portion thereof extending through the opening of the bottom of the chamber. A first seal assembly forms a first seal between the bearing extension and the bottom of the chamber, and a second seal assembly forms a second seal between the bearing assembly and the shaft.

### BACKGROUND OF THE INVENTION

Industrial dryers are used for drying a wide range of materials, such as dyes, bleach, sugar, flame retardants, carbon, fungicides, vitamins, and wood chips. These driers may include large drying chambers, where the materials are exposed to drying conditions for a period of time. Such drying conditions may include heat, desiccants, or continued movement of the materials. For example, the Turbo-Dryer®, manufactured by Wyssmont®, provides a large drying chamber with a number of trays stacked therein. The trays may rotate about a central shaft extending through the drying chamber and connected to a drive source. The material passes down each tray in the stack as the trays rotate, and heat is applied through a duct connected to the drying chamber. As a result, the material is thoroughly and evenly dried.

Because the drying chamber includes openings for apparatus such as the central shaft, it also presents an opportunity for drying conditions such as heat or gasses to escape. This results in increased consumption of energy and resources, and thus increased costs.

Currently, assemblies for sealing the openings are inadequate for processing materials under certain operating conditions such as where a closed environment is required or desirable. For example, as shown in FIG. 1, rotatable shaft 32 extends through an opening in a bottom plate 14 of the dryer. The shaft 32 is connected to a reducer 84 and a turntable sweeper 80 above a turntable 82. The turntable 82 is further connected to a first casting 70, which is connected to drive gears 88, located outside the drying chamber 89. Accordingly, while an upper portion of the first casting 70 extends above the opening in the bottom plate 14 into the drying chamber 89, a lower portion of the first casting 70 resides below. Thus, as the first casting 70 rotates air may escape through a space between the dryer bottom 14 and the casting 70.

As an attempt to solve this problem, seals have been placed between the dryer bottom 14 and the casting 70. For example, a seal plate 12 may be connected to the dryer bottom 14 and extend towards the casting 70. A packing gland 18 further extends towards the casting 70, with packing material 16 supported at a junction thereof by follower 31. However, this seal has proven ineffective in preventing leakages in certain applications. For example, problems arise as the first casting 70 rotates. Additionally, due to the size of the opening in the dryer bottom between the seal plates 12, a greater opportunity for leakage is presented. However, such size is necessitated by the positioning of the first casting 70.

Due to the deficiency of existing seal assemblies in preventing leakages, quantities of heat, gasses, and other agents employed within the dryer are wasted. In turn, costs of operating the dryer are increased, and resources are depleted more quickly. Accordingly, an improved sealing assembly is desired.

### SUMMARY OF THE INVENTION

An apparatus for processing materials according to an embodiment of the present invention provides a material processing chamber, formed from an enclosure, having a top and a bottom. The bottom has an opening therein, and a shaft extends through the opening and into the chamber. A bearing assembly may be arranged about a lower portion of the shaft, the bearing assembly including a bearing extension arranged about a portion of the shaft. The bearing extension has a portion thereof extending through the opening of the bottom of the chamber. A first seal assembly forms a first seal between the bearing extension and the bottom of the chamber, and a second seal assembly forms a second seal between the bearing assembly and the shaft.

In the above embodiment, the first seal assembly may comprise a seal plate connecting the dryer bottom and the bearing extension. As desired, packing material may be positioned proximal to a junction of the seal plate and the bearing extension. Optionally, a pressure purge, delivering a gas such as nitrogen, may provide increased pressure to an area surrounding the junction of the seal plate and the bearing extension.

The second seal assembly may include a casting surrounding the shaft, with packing material positioned between the casting and the shaft. Similar to the first seal assembly, a pressure purge may provide increased pressure to an area of the packing material.

An apparatus for processing materials according to another embodiment of the present invention includes a material processing chamber formed from an enclosure having a top and a bottom, the bottom having an opening therein. The apparatus further includes a shaft extending through the opening within the bottom and into the chamber, a bearing assembly concentrically arranged about a lower portion of the shaft, and a bearing extension connected to the bearing assembly and concentrically arranged about a portion of the shaft. The bearing extension may have a portion thereof extending through the opening of the bottom of the chamber. Further included is a seal assembly forming a seal between the bearing extension and the bottom of the chamber.

An apparatus for processing materials according to an even further embodiment of the present invention includes a processing chamber formed by at least one surrounding wall, a top wall, and a bottom wall having an opening. This apparatus further includes a rotatable shaft extending through the opening within the bottom and into the chamber. A bearing assembly having an extension surrounds the shaft as it extends through the opening within the bottom wall. A sealing system provides a seal about the extension of the bearing assembly as it extends through the opening within the bottom. The sealing system comprises a plate surrounding the extension within the opening, the plate attached to the bottom, and an enclosure coupled to the plate and the extension of the bearing assembly, the enclosure positioned proximal to a juncture of the plate and the extension. Further, packing material is provided within the enclosure for forming a seal at the juncture, and a gas source supplies a gas under pressure within the enclosure. A compression member associated with the enclosure applies a compressive force to the packing material.

### BRIEF DESCRIPTION OF THE DRAWINGS

FIG. 1 is a cross-sectional view of a sealing assembly according to prior art.

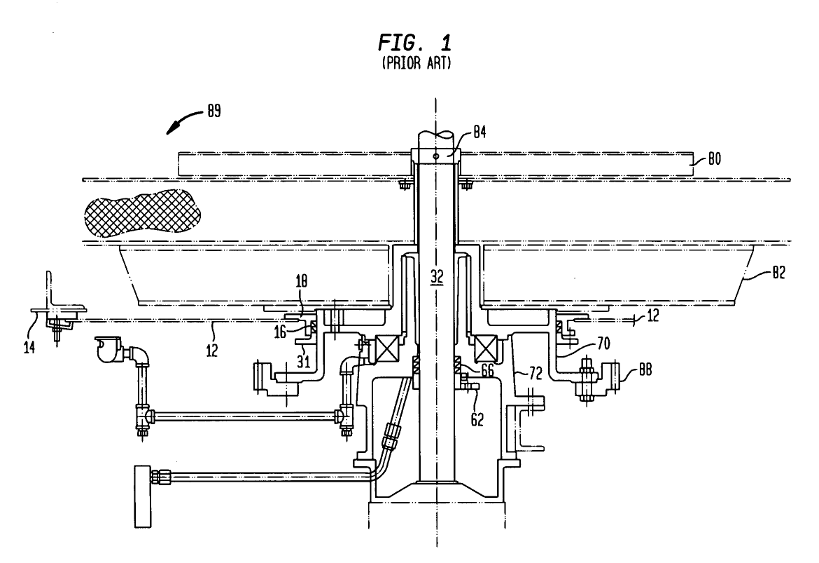

FIG. 2 is a cross-sectional view of an apparatus according to an embodiment of the present invention.

FIG. 3 is a cross-sectional view of a first sealing assembly and a second sealing assembly according to an embodiment of the present invention.

### DETAILED DESCRIPTION

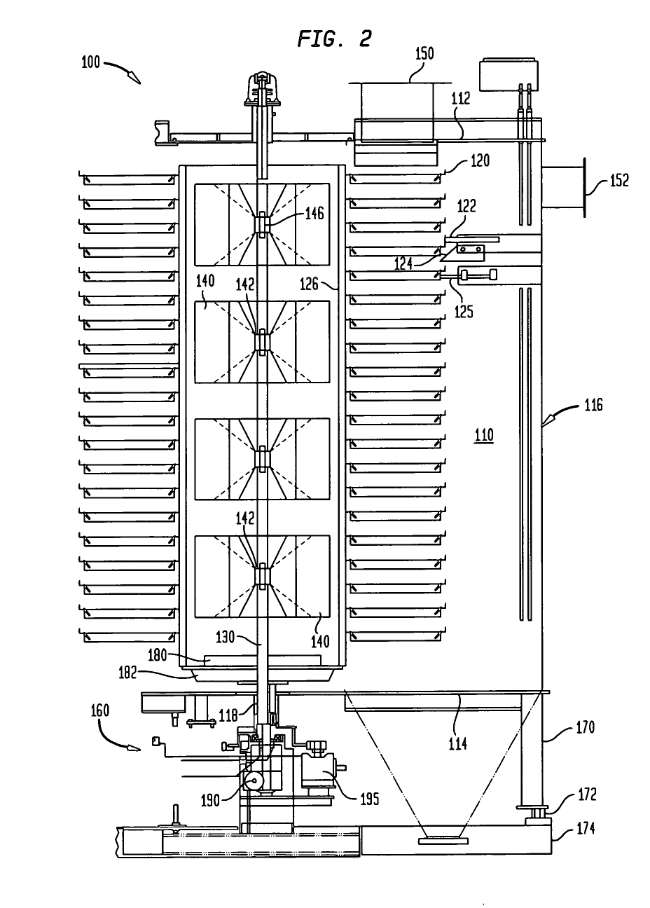

FIG. 2 shows an example of an apparatus 100 for processing materials according to an embodiment of the present invention. In this example, the apparatus 100 may be used to process (e.g., to dry) various materials, such as salts, powdered milk, or chemicals, as they undergo processing. In view of the improved seal assembly, to be described, the apparatus 100 has particular applications where a closed environment is desirable, such as in pyrolizing various materials (e.g., polymers). The apparatus 100 has particular application where toxic or reactive gasses may be used or are generated with the apparatus during use. The apparatus 100 includes a chamber 110, in this instance a drying chamber, wherein the materials are processed. The apparatus 100 further includes at least one drive assembly 160, which may power operations within the chamber 110, though being located outside.

The drying chamber is cylindrically enclosed by sidewall 116 which extends around the circumference of the chamber 110, a top plate 112, and a bottom plate 114. The chamber 110 is supported on a base 174 by supports 170 and connected expansion joints 172. The expansion joints 172 may be wheels attached to the supports 170. Alternatively, the expansion joints 172 may be wheels attached to the base 174 underneath the supports 170. In either embodiment, the expansion joints 172 enable the supports 170 to move as the chamber expands due to, for example, increased heat or gasses therein. This reduces stress applied to the structure of the apparatus 100.

Inside the chamber 110, the material to be processed may be placed on one or more stacked trays 120. Each tray is connected to a stanchion 126 which is attached around a shaft 130. Coupled to the stanchions 126 is a turntable 182. According to one embodiment, the turntable 182 is connected to a second shaft which surrounds the shaft 130.

As will be further described below, a bearing assembly 250 may also be attached to the turntable 182 as well as to drive gears 280, directly or indirectly. Accordingly, the drive gears 280 cause the bearing assembly to rotate, which in turn causes the turntable 182 to rotate. Further, the turntable 182 will cause the stanchions 126 and trays 120 to revolve.

A tray wiper 122 in the nature of a flat flexible panel may be positioned above each tray 120. As each tray 120 rotates, the tray wiper 122 transfers the material to the next tray. A rigidly mounted leveler 125 brushes across a top of the material placed thereon, thereby leveling the material and exposing materials underneath the top portion to the environment within the chamber 110. The material that is spilled by the tray wiper 122 falls onto catch plate 124. This plate 124, angularly positioned with respect to the trays 120, causes the material which is spilled off a tray 120 above to fall into a tray 120 below. In this manner, the material being processed cascades downwardly from the top tray to the bottom tray.

According to one aspect, a turntable sweeper 180 may be positioned above the turntable 182. The turntable sweeper 180 may prevent complications potentially caused by materials falling onto the turntable 182.

As the processed material is being rotated and moved as described above, further drying elements may be implemented within the chamber 110. For example, several sets of fan blades 140 may be included in the chamber 110 to facilitate circulation of gasses therein. The fan blades 140 may be connected to respective rings 142 which are coupled to the * shaft 130 by keys 146. The shaft 130 may extend beyond the bearing assembly 250 and connect to a reducer 190 at its lower end. The reducer 190 may be powered electrically, or by other sources such as a battery, steam, gas, or a mechanical crank. As the reducer 190 causes the shaft 130 to rotate, fan blades 140 would in turn rotate, thus pushing air across the trays 120.

The processed material may further be exposed within the chamber 110 to air or gasses provided through an inlet 152. For example, a duct may be connected to the inlet 152, and heated air, gasses, desiccants, or other inert, reactive, or non-reactive gasses may be provided to the chamber 110 through the duct. An exhaust 150 provides an outlet for the air or gasses. According to one embodiment, ducts connected to the exhaust may lead to a conditioning unit further connected to the inlet 152, thereby allowing the air or gasses to be recycled through the chamber 110.

The bearing assembly 250 provides additional support for the turntable 182, stanchions 126, and trays 120. The bearing assembly 250 may be formed of any of a variety of materials. Materials with increased strength and durability may be desirable in light of the weight supported by the assembly 250. Examples of such materials include steel, such as stainless steel, cast iron, or any of a variety of other metals.

The bearing assembly 250 includes a support plate 252 attached beneath the turntable 182, an extension 254 extending alongside the shaft 130, and a base plate 256. According to one embodiment, the extension 254 may be cylindrical, surrounding a portion of the shaft 130. The support plate 252 and base plate 256 may be circular, and thus connected to the extension 254 around its circumference.

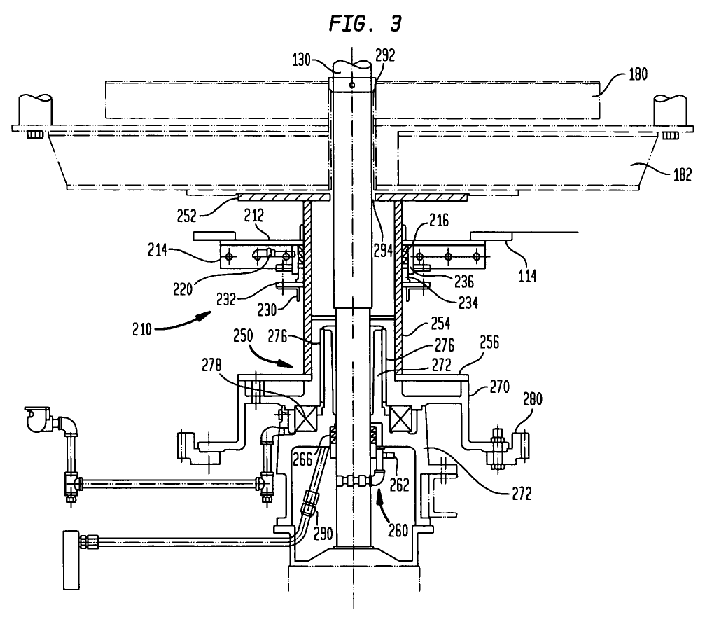

To prevent the air or gasses provided to the chamber 110 from escaping, seal assemblies are placed around the shaft 132 and near the opening 118. As better seen in FIG. 3, a first seal assembly 210 is implemented to prevent leakages through the opening 118 in the bottom plate 114. A seal plate 212 is connected to the bottom plate 114 and extends to the bearing extension 254. A clamp 214 may be used to secure the seal plate 212 to the bottom plate 114.

Packing material 216 may be positioned at a point where the seal plate 212 meets the bearing extension 254. The packing material 216 may be vinyl, asbestos, or any other type of packing material. According to one embodiment, the packing material 216 may include a lantern ring 236. Additionally, a follower 234 may be positioned beneath the packing material 216. The follower 234 may be supported by gland 232 and stiffener 230.

According to a further aspect, the first sealing assembly 210 may additionally include a purge 220, such as a nitrogen purge, to operate in conjunction with the packing material 216 and surroundings. For example, a source may provide nitrogen gas through the purge 220 to the packing material 216. According to one embodiment, the nitrogen gas would cause the packing material 216 to expand. However, the lantern ring 236, follower 234, gland 232 and stiffener 230 will provide a boundary or even a reactive force against the packing material 216. Thus, the packing material 216 will be forced to fill any openings between the seal plate 212 and the bearing extension 254 as it expands.

A second seal assembly 260 may be implemented to prevent leakages along the shaft 130. For example, air or gasses may leak through a space 292 between the turntable 182 and the shaft 130, further through a space 294 between the support plate 252 and the shaft 130, and downwardly along a length of the shaft 130. Accordingly, second seal assembly 260 may be implemented as described in more detail below.

As mentioned above, the shaft 130 may extend to connect to the drive assembly 160. As shown in FIG. 3, the bearing assembly 250 extends around a portion of the shaft 130. According to one embodiment, the bearing assembly 250 may include a first casting 270, which connects to drive gear 280. A second casting 272 may partially reside within the first casting 270, with bushings 276 positioned between the first casting 270 and second casting 272. The first and second castings 270, 272 may be formed of any of a variety of materials. For example, the castings 270, 272 may be plastic, ceramic, polymer, metal, or any other material.

According to one embodiment, the first casting 270 and bearing assembly 250 may rest partially on top of the second casting 272. In this regard, the first casting 270 and bearing assembly 250 may rotate as the second casting 272 remains stationary. Such rotation may be facilitated by the bushings 276, as well as by thrust bearing 278. The thrust bearing 278 may be spheres or rollers held in place between the first casting 270 and second casting 272, thereby reducing friction between the elements.

The second seal assembly may be located between the second casting 272 and the shaft 130. Similar to the first seal assembly 210, the second seal assembly 260 may include packing material 266 positioned between the second casting 272 and the shaft 130. Gland 262 may be positioned beneath the packing material 266, and a purge 290 may be fed to the packing material 266. The purge 290 may provide a gas or fluid, such as nitrogen. The gland 262 keeps the packing material 266 compressed, thereby preventing any leakage. As seen in the second seal assembly 260 of FIG. 3, the gland 262 may be an “L” shaped piece of metal or plastic supported underneath the packing material 266, as opposed to the combination of follower 234 and straight gland 232 used in the first seal assembly 210.

As can be seen, the first seal assembly 210 prevents leakages through the opening 118 while the second seal assembly 260 prevents leakages through and/or around the shaft 130. These seal assemblies 210, 260 may be used either alone or in conjunction with one another. Regardless, each assembly 210, 260 permits rotation of the shaft 130 and the bearing extension 254 without sacrificing resources.

As mentioned above, the purges 220, 290 provided in the first and second seal assemblies 210, 260 may cause the packing materials 216, 266 to expand. Alternatively or additionally, the purges 220, 290 may provide an increased air pressure to areas surrounding the seals. Accordingly, the increased pressure with respect to the pressure in the chamber 110 prevents air or gasses from escaping the chamber 110.

Although the chamber 110 in the apparatus 100 described above is a drying chamber, it should be understood that the first sealing assembly 210 and the second sealing assembly 260 may be used to prevent leakages from any type of material processing chamber. For example, the chamber 110 may encapsulate processes for, inter alia, freezing, grinding, purifying, pulverizing, separating, or sublimating. Further, the chamber 110 may be any of a variety of sizes and shapes.

Moreover, the inlet 152 may provide any of a variety of fluids or gasses to the chamber 110. Accordingly, while providing hot air and a desiccant may be most desirably provided to a drying chamber, providing a different type of gas or fluid may be more desirable for a different process.

Further, the gasses or fluids provided through purges 220 and 290 may vary in relationship to the gasses or fluids in the chamber 110. For example, nitrogen gas (N₂) may provide a higher pressure at the first and second seal assemblies 210, 260 to further prevent gasses from escaping the chamber 110. However, if a process within the chamber 110 involved circulation of nitrogen gas, a different gas may be provided through purges 220, 290.

Shaft 130 may be formed of metal or any variety of other materials. Further, although the apparatus 100 as described herein includes a rotating shaft 130, the shaft 130 may be capable of other motions, such as gyrating.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus for processing materials, the apparatus comprising:
a material processing chamber formed from an enclosure having a top and a bottom, the bottom having an opening therein,
a shaft extending through the opening within the bottom and into the chamber,
a bearing assembly arranged about at least a portion of the shaft,
a bearing extension connected to the bearing assembly and arranged about a portion of the shaft, the bearing extension having a portion thereof extending through the opening in the bottom of the chamber,
a first seal assembly forming a first seal between the bearing extension and the bottom of the chamber, and
a second seal assembly forming a second seal between the bearing assembly and the shaft.

2. The apparatus of claim 1, wherein the first seal assembly comprises a seal plate extending between the bottom of the chamber and the bearing extension within said opening.

3. The apparatus of claim 2, wherein the first seal assembly further comprises packing material proximal to the junction of the seal plate and the bearing extension.

4. The apparatus of claim 2, wherein the first seal assembly further comprises a pressure purge adapted for providing fluid pressure to an area surrounding the junction of the seal plate and the bearing extension.

5. The apparatus of claim 4, wherein the pressure purge is adapted to provide nitrogen (N₂) gas.

6. The apparatus of claim 2, wherein the first seal assembly further comprises:
packing material proximal to the junction of the seal plate and the bearing extension;
a pressure purge adapted for providing a gas to an area of the packing material; and
at least one element connected to the bearing extension adjacent to the packing material, the at least one element adapted for compressing the packing material.

7. The apparatus of claim 1, further comprising a casting surrounding at least part of a portion of the shaft which extends outwardly from the bearing assembly.

8. The apparatus of claim 7, wherein the second seal assembly comprises packing material positioned between the casting and the shaft.

9. The apparatus of claim 8, wherein the second seal assembly further comprises a pressure purge adapted for providing increased pressure to an area of the packing material.

10. The apparatus of claim 9, wherein the pressure supplied to the packing material is a higher pressure than that inside the chamber, so that gas cannot escape from the chamber.

11. The apparatus of claim 9, wherein the pressure purge is adapted to provide nitrogen (N₂) gas.

12. The apparatus of claim 9, wherein the second seal assembly further comprises at least one element supporting the packing material adapted for compressing the packing material.

13. An apparatus for processing materials, the apparatus comprising:
a material processing chamber formed from an enclosure having a top and a bottom, the bottom having a central opening therein,
a shaft extending through the central opening within the bottom and into the chamber,
a bearing assembly concentrically arranged about the shaft adjacent to the bottom of the chamber,
a bearing extension connected to the bearing assembly and concentrically arranged about a portion of the shaft, the bearing extension having a portion thereof extending through the central opening of the bottom of the chamber, and
a seal assembly forming a seal between the bearing extension and the bottom of the chamber.

14. The apparatus of claim 13, wherein the seal assembly comprises a seal plate extending between the bottom of the chamber and the bearing extension within said central opening.

15. The apparatus of claim 14, wherein the seal assembly further comprises packing material proximal to a junction of the bottom of the chamber and the bearing extension.

16. The apparatus of claim 14, wherein the seal assembly further comprises a pressure purge adapted for providing fluid pressure to an area surrounding a junction of the bottom of the chamber and the bearing extension.

17. The apparatus of claim 16, wherein the pressure supplied to the packing material is a higher pressure than that inside the chamber, so that gas cannot escape from the chamber.

18. The apparatus of claim 16, wherein the pressure purge is adapted to provide nitrogen (N₂) gas.

19. The apparatus of claim 14, wherein the seal assembly further comprises:
packing material proximal to a junction of the seal plate and the bearing extension;
a pressure purge adapted for providing a gas to an area of the packing material; and
at least one element connected to the bearing extension adjacent to the packing material, the at least one element adapted for compressing the packing material.

20. The apparatus of claim 14, wherein a portion of the shaft extending outwardly from the chamber is reduced in diameter.

21. The apparatus of claim 20, further comprising a second seal assembly forming a second seal between the bearing assembly and the portion of the shaft reduced in diameter.

22. The apparatus of claim 21, wherein the second seal assembly comprises:
a casting surrounding an exposed portion of the shaft;
packing material positioned between the casting and the shaft;
a pressure purge adapted for providing a gas to an area of the packing material; and
at least one element supporting the packing material, the at least one element adapted for compressing the packing material as it expands.

23. An apparatus for processing materials, the apparatus comprising:
a processing chamber formed by at least one surrounding wall, a top wall, and a bottom wall having an opening;
a rotatable shaft extending through the opening within the bottom wall and into the chamber;
a bearing assembly having an extension surrounding the shaft as it extends through the opening within the bottom wall, and
a sealing system for providing a seal about the extension of the bearing assembly as -it extends through the opening within the bottom wall, the sealing system comprising:
a plate surrounding the extension within the opening, the plate attached to the bottom wall,
an enclosure coupled to the plate proximal to a juncture of the plate and the extension,
packing material provided within the enclosure for forming a seal at the juncture,
a fluid source for supplying a fluid under pressure within the enclosure, and
a compression member associated with the enclosure for applying a compressive force to the packing material.

24. The apparatus of claim 23, wherein the bearing assembly includes a first casting positioned proximal to a second casting, wherein the first casting is rotatable with respect to the second casting.

25. The apparatus of claim 24, further comprising at least one of a bushing or a roller between the first casting and second casting.
